(19) United States
(12) Patent Application Publication
(10) Pub. No.: US 2009/0281845 A1
(43) Pub. Date: Nov. 12, 2009

(54) METHOD AND APPARATUS OF CONSTRUCTING AND EXPLORING KPI NETWORKS

(75) Inventors: Mari Fukuda, Kanagawa-ken (JP); Jun-Jang Jeng, Armonk, NY (US); Yinggang Li, Redmond, WA (US)

Correspondence Address: SCULLY, SCOTT, MURPHY & PRESSER, P.C., 400 GARDEN CITY PLAZA, SUITE 300, GARDEN CITY, NY, 11530, US

(73) Assignee: INTERNATIONAL BUSINESS MACHINES CORPORATION, Armonk, NY (US)

(21) Appl. No.: 12/115,913

(22) Filed: May 6, 2008

(51) Int. Cl. G06Q 10/00

(52) U.S. Cl. 705/7

(57) ABSTRACT

A method and system for constructing and exploring KPI networks, in one aspect, identified KPIs associated with a performance target. Correlated or dependent KPIs are determined and correlations or dependencies are weighed to provide the degree of relevance in the KPI network. Influential chains in the correlation are determined. KPIs and associated correlations may be mined using historical data.

### FIELD OF THE INVENTION

The present disclosure relates to data representation, transformation and analysis for business performance monitoring, and particularly to a method and system for modeling key performance indicators for generating monitoring applications.

### BACKGROUND OF THE INVENTION

While scientific visualization and information visualization have long histories of fruitful research, the business oriented visualization has recognized the need (and opportunity) to create a more unified vision of the problem-solving process, as it pertains to visualization tasks. Recently, the visualization research community has centered upon the term “Visual Analytics” to encompass the complete lifecycle of activities encountered while developing and using visualizations to solve problems.

Key Performance Indicators (KPIs) are quantifiable measurements, agreed to beforehand, that reflect the critical success factors of an organization. BPM (business performance management) normally has a data warehousing and business intelligence foundation. Data warehouses integrate data from multiple sources to deliver KPIs and detailed reports. Some organizations report handful of metrics such as divisional profit or turnaround times. Others rely on a larger number of metrics, which collectively may not spell out the business strategy or cover all the dimensions of business process that should be considered. Neither extreme is satisfactory. Thus, by failing to adopt an effective set of KPIs for managing business performance, many businesses may be overlooking actions vital to achieving their full innovation potential.

However, traditional business intelligence tools display data in the formats such as dashboard, scorecard, and detailed reports, which may not be appropriate for KPI data exploration. Dashboard prescribes a limited number of performance measures in several categories that are predefined by experts. The focus of dashboard is to provide users with a timely snapshot of how each KPI is performing against business objectives; therefore it lacks means of conducting multi-variant analysis on KPI connectivity. The balanced scorecard approach generally consists of 20-25 measures that represent a combination of outcome KPIs and drivers of future performance. The personalized business views in scorecard do not support effective impact analysis so as to validate scorecard design.

Thus, what is desirable is a system and method that provides visualization functionality for presenting KPIs in a form that users can easily consume and delivering composite view that matches user's business process understanding. Discovering and analyzing KPI relationships, a business user can better communicate and execute business strategy at all levels and gain greater visibility into organizational performance reflected through KPI network.

### BRIEF SUMMARY OF THE INVENTION

A method and system for constructing and exploring KPI networks are provided. The method in one aspect may comprise identifying one or more key performance indicators associated with a selected performance target and determining one or more correlations to said one or more key performance indicators. The method may also include assigning weights to said one or more correlations. The weights represent an influence value between correlated key performance indicators. The method may further include determining one or more influential chains in said one or more correlations. The influential chains indicate one or more factors affecting the selected performance target.

A system for constructing and exploring KPI networks, in one aspect, may comprise a computer implemented processing module operable to identify one or more key performance indicators associated with a selected performance target. A computer implemented analytic module determines one or more correlations to said one or more key performance indicators and generates a key performance indicator network comprising said one or more key performance indicators and said one or more correlations. A processing module determines one or more influential chains in said one or more correlations. The influential chains indicate factors affecting the selected performance target.

A program storage device readable by a machine, tangibly embodying a program of instructions executable by the machine to perform a method of constructing and exploring KPI networks may be also provided.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIG. 1 illustrates KPI design cycle in one embodiment of the present disclosure.

FIG. 2 is a diagram showing the architecture in one embodiment of the tool of the present disclosure with a control flow from a data warehouse to a monitor model.

FIG. 3 illustrates an example of a user interface screen shot of the tool in one embodiment of the present disclosure.

FIG. 4 illustrates a dependency learner screen shot.

FIG. 5 shows dependency graph of automobile data with 8 KPIs and their correlations.

FIG. 6 shows a control flow in the control flow editor in one embodiment or the present disclosure.

FIG. 7 shows an example of a resulting KPI Net saved by the tool.

FIG. 8 is a flow diagram illustrating a method of KPI design cycle in one embodiment of the present disclosure.

FIG. 9 illustrates an example of a graphical editor for KPI Net construction in one embodiment.

FIG. 10 illustrates an example of constructed KPI Net.

FIG. 11 illustrates a KPI Network with a loop in a tree layout and the loop broken.

FIG. 12 illustrates and example of color and shape coded KPI Net.

FIG. 13 illustrates data range brushing with parallel coordinate display.

### DETAILED DESCRIPTION

A process of BPM (business performance management) related information discovery in visual exploration system is disclosed. This disclosure describes visualization activities that provide insight, for example, to complex problems in massive and complex business metric datasets, and enhance human element in detecting patterns and relationships. Business visual exploration may include data representations and transformations, also referred to as KPI net construction, visual representations and interaction techniques, and analytical reasoning. An inter-connected KPI network, aliased as KPI Net, organizes KPI as nodes in a cohesive and concerted way. The network linkage tries to capture business process or relationships among selective KPIs. The KPI Net visual exploration facilitates data interpretation and information discovery that are not available in conventional dashboard and scorecard.

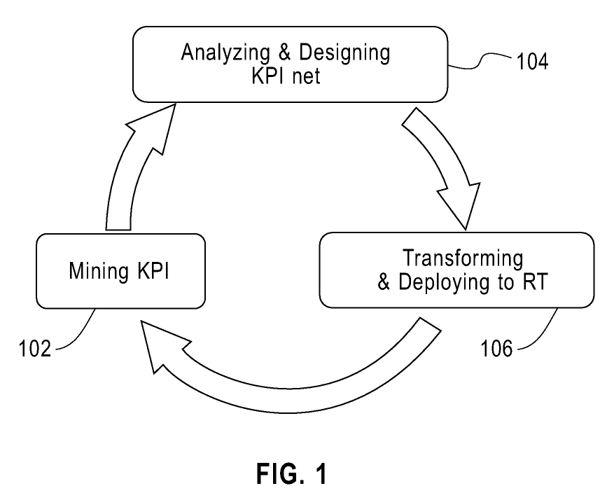

An embodiment of the method and system of the present disclosure provides modeling environment for KPI service composition design cycle. Modeling KPIs (Key Performance Indicators) that are metrics used to compute business situations can provide valuable insight to the business users. KPI design cycle and requirements of KPI modeling provide inputs for continuous improvement of Enterprises. FIG. 1 illustrates KPI design cycle in one embodiment of the present disclosure. Shown at 102, KPIs are mined from a knowledge database with historical data. Process mining techniques allow exploring of process flows in running applications. Process mining can show the actual situation of the business process that can be used for analytic purposes, and users do not need to design a process from scratch, but can use rough process descriptions. In one embodiment, the initial monitor-enabled KPI is given by the knowledge database schema. Mining KPI and their correlations, for example, may be performing using learning algorithms to identify KPIs (or variables) that are most significantly correlated with other variables. The degree of significance is determined by the outcome of the analysis performed by so-called KPI explorer, where the sensitivity of impact from one KPI on another (pair-wise) is computed. The more sensitive a KPI X to the change of KPI Y than that of KPI Z, then Y is more significant to X than Z to X.

At 104 KPI network is analyzed and designed using the identified KPIs and correlations from 102. The mining step usually counts a large number of KPI correlations and does not identify which KPI should be focused for human monitoring. At step 104, the number of monitor-enabled KPIs is reduced via impact analysis, sensitivity analysis, and other business-oriented analytic methods. A KPI Network or a “KPI Net” for short is output from this analytics of step 104, which describes KPI elements and the relations between them. This step also includes comparing the monitor-enabled KPIs and the to-be-monitored KPIs. To-be-monitored KPI represents a KPI that should be monitored for important business reasons but is not included in historical data. By comparing these two types of KPIs, a shortage of the current viewpoints of business management can be identified.

Step 106 shows transforming and deploying KPI Net to runtime. Even if an enterprise decides that the organization structure changes for reasons such as outsourcing, it might use the same KPIs to measure business performance. In one embodiment of the present disclosure, how the business process works and what kinds of measurement used are treated as different processes. Thus, in one embodiment, KPI is designed to be insulated from the change of process model and designed independently of process modeling at least initially. Then models of the KPIs and of the processes may be combined to discover and define KPIs.

In one embodiment of the present disclosure, a plurality of modeling requirements of KPIs are defined to provide KPI design cycle support. Examples of requirements that satisfy KPI modeling may include the following.

Why is a KPI monitored: A KPI element may be linked to the business goals of an enterprise. The Goal-Question-Metric (GQM) approach is known as an effective approach of maintaining meaningful metrics for software measurements. The business goals linked to a KPI are defined explicitly in a model, which in turn, gives the monitoring applications a focus for KPI monitoring.

What kinds of KPIs should be monitored: Defined KPI in a goal model is a high-level KPI and usually derived from finer-grained, operational KPIs. The KPI Net described above includes KPI elements and the relations among them. There are predefined types of functions: computational relations that are defined arithmetically; dependency relations that are discovered as correlations by mining engines. A set of KPIs may be defined during consultations with business managers. A KPI Net provides the structure for KPIs and thus allows drilling down from high-level KPIs to low-level ones.

How should a KPI be calculated: A KPI is calculated from other KPIs and/or business event attributes. Business events are retrieved from business process workflow engines, log file adapters, legacy applications implemented to emit events, and other sources during monitored operations. At design time, event sources are identified with adaptation elements called sensors in a KPI Net. A sensor sometimes refers to a repository of event metadata, historical data of simulations, etc. based on the kinds of events that can be retrieved from an event source. To define KPI relations, users may discover computational relations from events, with pre-conditions and post-conditions to evaluate relations.

What is the context of a KPI: When a KPI is defined, the context of monitoring the KPI may be also defined. For example, if a KPI “product sales” is defined, categories of products may be one of contexts of monitoring, as business managers want to see what kinds of products are selling well. Such business concerns may be defined at an early stage of modeling and then transformed to a runtime configuration based on the model-driven approach. In another embodiment, software developers may identify the source code related to the business concerns when contexts are changed.

When should a KPI be evaluated: Relations between KPIs include formulation of the relation, preconditions, and post conditions to evaluate those functions. The timing of evaluation depends on the meaning of a KPI and its functions. If a KPI is “1Q Sales” then the time to evaluate it is at the end of March, for example. But if the KPI is, for instance, “Sales by each representative”, then the timing depends on when the sales events occurred. In one embodiment, the timing of evaluation may include at least three types and their combinations: periodic (e.g., once a month), triggered when input data satisfies conditions (e.g., when data is updated), or specific times (e.g. the end of March).

Who can monitor the KPI: In monitoring applications, users do not make decisions or take actions until they see a KPI on a dashboard. For this reason, a KPI has to have an access control policy as an attribute to be transformed into security policies on a runtime platform. However it is not always satisfactory if it only supports “who can access which KPI” and does not consider contextual information. For example, a user can access KPI A. After it reaches a threshold, then perhaps that person should not be allowed to access KPI B in the same monitoring context. Access control mechanisms for inter-organizational workflows have been proposed to separate inter-organizational workflow security from concrete organization-level security enforcement. Similarly, access control mechanisms and runtime platforms for business performance monitoring are needed apart from modeling access control for KPI to reflect dynamic demands.

The above-described factors are some examples of basic requirements for modeling environment in KPI applications.

An embodiment of the present disclosure provides a tool framework for KPI application development. The tool of the present disclosure in one embodiment enables mining and modeling KPI net, analyzing KPI net and supporting smooth model transformation to KPI applications based on the model driven approach. The tool may be implemented as a set of plugins for a platform. For example, some of the plugins may utilize Rational Software Architect and exploit UML editing functions. The tool also may include core plugins and extension plugins. In addition, standard technology such as the Eclipse platform may be used to implement the tool.

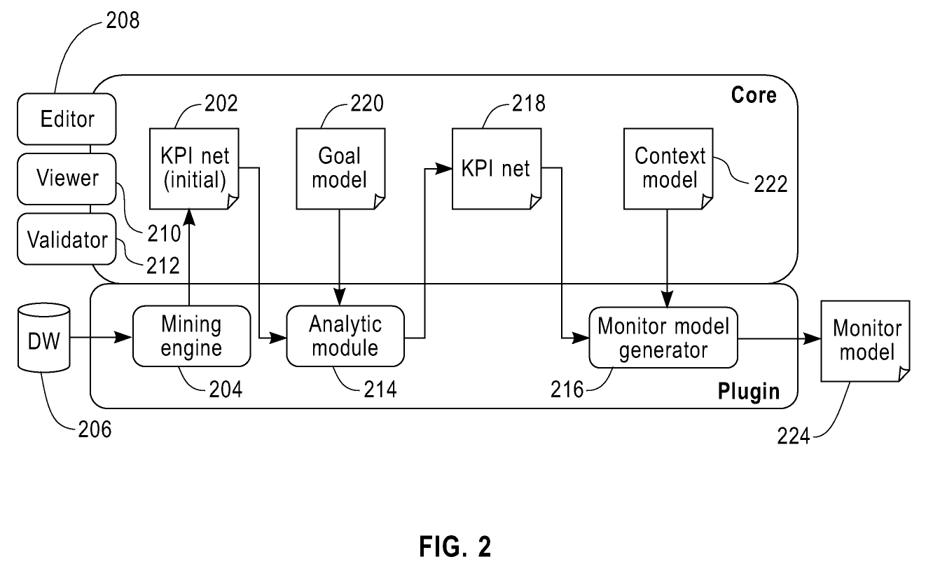

FIG. 2 is a diagram showing the architecture in one embodiment of the tool of the present disclosure with a control flow from a data warehouse to a monitor model. The core plugins may provide editing 208, viewing 210, and validating 212 functions for designing models. The extension plugins may provide mining engines 204, analytic modules 214, monitor model generators indicating services 216. The extension plugins can be added with service interfaces to adapt to users' needs. The tool can be a powerful platform to compose services and build KPI applications. With the tool, the control flow also can be designed in the editor.

FIG. 2 describes a control flow from a data warehouse (DW) to a monitor model, from the left to the right in the figure, through extension plugins indicating services. A set of KPIs 202 is extracted from the data warehouse 206 or like with a data mining engine 204 or like. The data warehouse 206 can be replaced with a business process or like depending on the application scenario.

In another embodiment, a user may use a graphical editor to specify pair wise relationship between KPIs. The relationship may be defined as a function map from KPI x to KPI y. An editor may list in one column all KPIs as independent variable x, while another column lists the same KPIs suffixed as dependent variable y. A user may draw a direct linkage from one or more values of one column to one or more values of the other column to draw links between the KPIs. In addition, a relevance factor or weight may also be supplied by the user.

An analytic module 214 calculates or generates a KPI Net 218 comprising a set of KPIs and their relations from the mined KPIs 202 and the Goal model 220. In one embodiment, the goal model 220 determines the focal KPIs according to the enterprise strategy. The goal model 220 thus may be replaced with a different goal model for each enterprise. Explained another way, each enterprise may have its own goal model which may be unique to the enterprise's strategy and goals. The KPI Net 218 is transformed to generate a monitor model 224 by adding a context model 222 with the generator 216. The context model 224 may be customer segments for a customer relationship management application, and/or product categories for a supply chain management application.

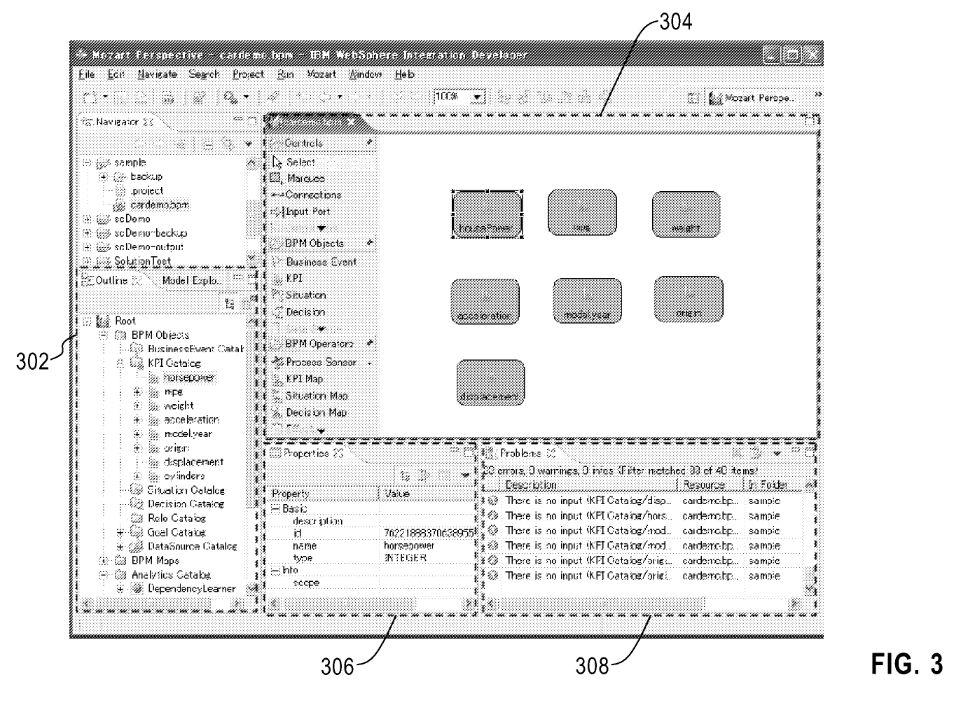

In addition, a control flow diagram such as those shown in FIG. 2 can be edited in the tool and applied towards developing KPI applications. FIG. 3 illustrates an example of a screenshot of the tool in one embodiment. The tool may include several views and editors. The metamodel of KPI Net may be defined using standard technology such as a UML class diagram and an instance serialized in the XML Metadata Interchange (XMI) format. In one embodiment of the present disclosure, opening a model file allows users to access various views and editors. For examples, one or more elements of the model are presented in a list as a catalog view 302. There is a set of KPI elements in the “KPI Catalog” (310). Users can drag and drop elements into the KPI Net Editor 304 which displays the KPI Net. The KPI Net Editor 304 can be switched to other editors such as the Goal editor, Control flow editor, etc., responding to the selections of elements in the Catalog view 302. If the KPI elements do not have any relationships to others, the set of KPI elements are displayed as shown in the example. The element attributes are shown in the Property view 306. A validator validates the model before it is saved. It shows the validation results in the Problems view 308 with validation error messages, if any.

The following illustrates an example scenario of mining KPI from an automobile business dataset to generate a monitor model according to the method and system of the present disclosure in one embodiment. Once a monitor model is generated, it can be transformed and deployed on the runtime. In this scenario, steps of the design cycle, which include at least mining a KPI and analyzing and designing a KPI Net are explained. The step of transforming and deploying to runtime may be performed using methodology, for example, described in M. Abe, J. Jeng, and T. Koyanagi. Authoring Tool for Business Performance Monitoring and Control. In Proceedings of IEEE International Conference on Service-Oriented Computing and Applications (SOCA 2007), June 2007; and M. Abe, T. Koyanagi, J. Jeng, and L. An. An Environment of Modeling Business Centric Monitoring and Control Applications. In Proceedings of IEEE International Conference on e-Business Engineering (ICEBE 2006), October 2006, which disclosures are incorporated herein in their entirety by reference.

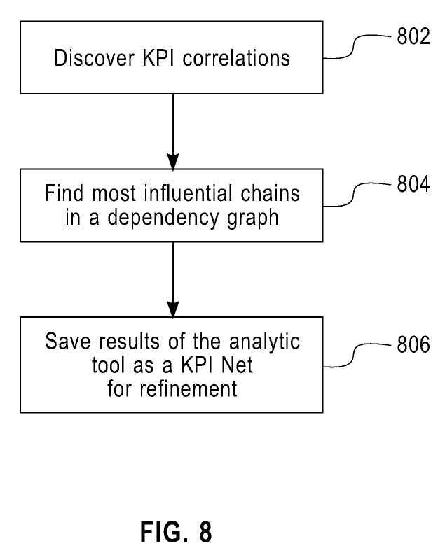

FIG. 8 is a flow diagram illustrating a method of KPI design cycle in one embodiment of the present disclosure, using the above example above scenario of automobile business. The example scenario includes the following tasks in sequence: discovering KPI correlations 802; finding the most influential chains in a dependency graph 804; and saving results of the analytic tool as a KPI Net for refinement 806. In one embodiment, the original dataset can be downloaded from the UCI Machine Learning Repository. Suppose that an automobile maker needs to check if a KPI, miles per gallons (mpg), of a new car can be improved to meet an environmental fuel efficiency objective. The question is which KPIs should be paid attention to reach such a goal in a process of car re-designing. The motivation is that it is difficult to design a KPI Net from scratch. Also, it is difficult to predict how much each KPI influences the others. The tool of the present disclosure allows users or businesses to easily determine correlations to such KPI.

TABLE 1

| name | mpg | Cylinders | displacement | horsepower | weight |
|---|---|---|---|---|---|
| amc- | 18.0 | 8.0 | 307.0 | 130.0 | 3504.0 |
| ambassador- | | | | | |
| brougham | | | | | |
| amc- | 15.0 | 8.0 | 350.0 | 165.0 | 3693.0 |
| ambassador- | | | | | |
| dpl | | | | | |
| amc- | 18.0 | 8.0 | 318.0 | 150.0 | 3436.0 |
| ambassador- | | | | | |
| sst | | | | | |
| amc-concord | 16.0 | 8.0 | 304.0 | 150.0 | 3433.0 |
| amc-concord | 17.0 | 8.0 | 302.0 | 140.0 | 3449.0 |
| amc-concord- | 15.0 | 8.0 | 429.0 | 198.0 | 4341.0 |
| d/l | | | | | |
| amc-concord-dl | 14.0 | 8.0 | 454.0 | 220.0 | 4354.0 |
| amc-concord- | 14.0 | 8.0 | 440.0 | 215.0 | 4312.0 |
| dl-6 | | | | | |
| amc-gremlin | 14.0 | 8.0 | 455.0 | 225.0 | 4425.0 |
| amc-gremlin | 15.0 | 8.0 | 390.0 | 190.0 | 3850.0 |

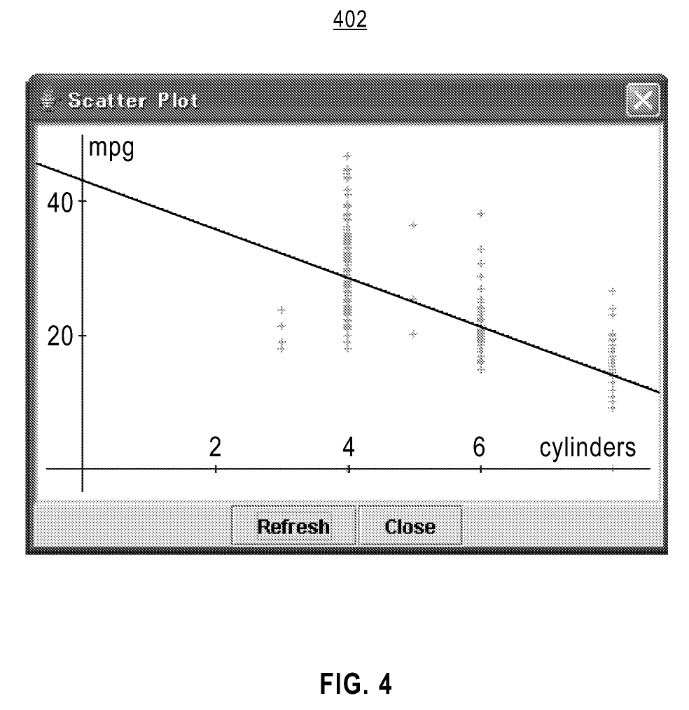

At 802, KIP correlations are discovered. Table 1 shows sample values of automobile parameters or KPIs for each model of automobile or car. While there may be many types of KPIs and number of data entries, Table 1 shows a small part of the sample data. From such historical data, KPI correlations are discovered, for example, by using simple linear regression, most often used for prediction between pairs of parameters. Other prediction algorithms may be employed. FIG. 4 illustrates a dependency learner screen shot. A mining engine may provide such services. The dependency learner screen shot 402 shows correlations between two KPIs. This figure illustrates a mined correlation between cylinders and mpg with a slope −3.6, where the X-axis is the number of cylinders and the Y-axis is mpg. One cross dot on plot corresponds to one record in Table 1. The points are grouped on discrete numbers on the X-axis because the number of cylinders has discrete values. This figure shows that as the number of cylinders increases, the mpg generally decreases.

The following shows a part of WSDL file of Dependency learner service. The header, namespace declaration, definitions of types, encoding style and namespaces of SOAP are omitted. The following WSDL file content shows the interface of how to get a dependency and a dependency graph. There are two operations “getDependency” and “getDependencyGraph”. It also shows message formats of the two operations. From these dependencies, a dependency graph may be obtained.

```
<wsdl:message name=“getDependencyResponse”>
    <wsdl:part name=“getDependencyReturn” type=“xsd:double”/>
</wsdl:message>
<wsdl:message name=“getDependencyGraphResponse”>
    <wsdl:part name=“getDependencyGraphReturn”
        type=“impl:DependencyGraph”/>
</wsdl:message>
<wsdl:message name=“getDependencyRequest”>
    <wsdl:part name=“x” type=“impl:ArrayOf_xsd_double”/>
    <wsdl:part name=“y” type=“impl:ArrayOf_xsd_double”/>
</wsdl:message>
<wsdl:message name=“getDependencyGraphRequest”>
    <wsdl:part name=“KPIList_X” type=“impl:ArrayOfKPI”/>
    <wsdl:part name=“KPIList_Y” type=“impl:ArrayOfKPI”/>
    <wsdl:part name=“dependencyList”
        type=“impl:ArrayOf_xsd_double”/>
</wsdl:message>
<wsdl:portType name=“DependencyLearner”>
    <wsdl:operation name=“getDependency”
            parameterOrder=“in0 in1”>
        <wsdl:input message=“impl:getDependencyRequest”
                name=“getDependencyRequest”/>
        <wsdl:output message=“impl:getDependencyResponse”
                name=“getDependencyResponse”/>
    </wsdl:operation>
    <wsdl:operation name=“getDependencyGraph”
            parameterOrder=“in0 in1 in2”>
        <wsdl:input message=“impl:getDependencyGraphRequest”
                name=“getDependencyGraphRequest”/>
        <wsdl:output message=“impl:getDependencyGraphResponse”
                name=“getDependencyGraphResponse”/>
    </wsdl:operation>
</wsdl:portType>
<wsdl:binding name=“DependencyLearnerSoapBinding”
        type=“impl:DependencyLearner”>
    <wsdlsoap:binding style=“rpc”
            transport=“http://schemas.xmlsoap.org/soap/http”/>
    <wsdl:operation name=“getDependency”>
        <wsdlsoap:operation soapAction=“”/>
        <wsdl:input name=“getDependencyRequest”/>
        <wsdl:output name=“getDependeneyResponse”/>
        </wsdl:output>
    </wsdl:operation>
    <wsdl:operation name=“getDependencyGraph”>
        <wsdlsoap:operation soapAction=“”/>
        <wsdl:input name=“getDependencyGraphRequest”/>
        <wsdl:output name=“getDependencyGraphResponse”/>
    </wsdl:operation>
</wsdl:binding>
<wsdl:service name=“DependencyLearnerService”>
    <wsdl:port binding=“impl:DependencyLearnerSoapBinding”
            name=“DependencyLearner”>
        <wsdlsoap:address location=“http://localhost:8080/
            axis/services/DependencyLearner”/>
    </wsdl:port>
</wsdl:service>
```

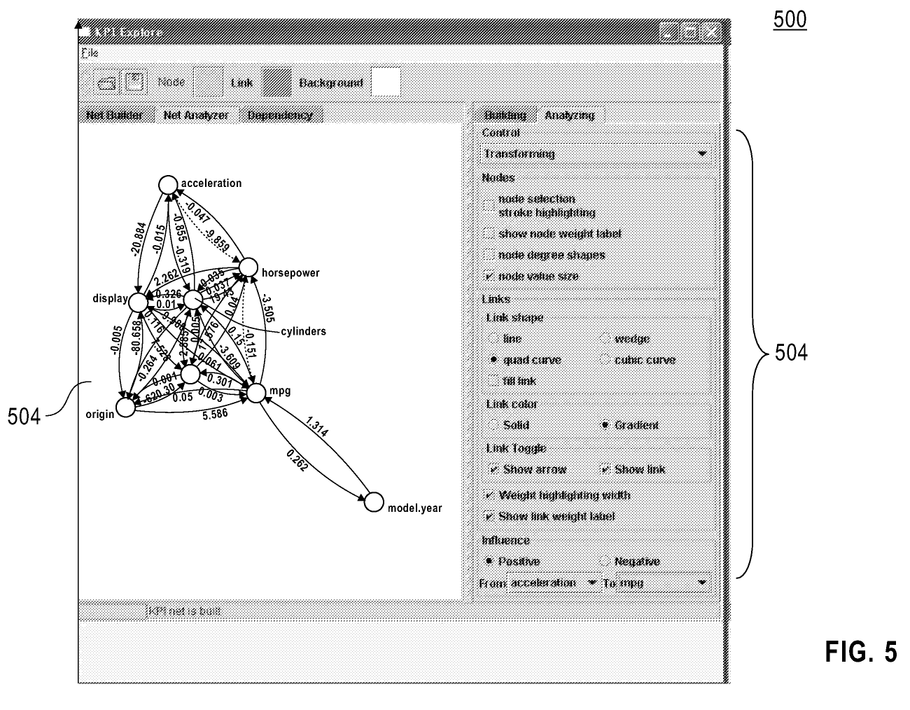

FIG. 5 shows dependency graph of automobile data with 8 KPIs and their correlations. It shows most influential chains in one graph. Each node indicates a KPI and each weighted, directed edges represents mutual correlations as influence between two nodes. The weight is the numeric influence between two KPIs, which may be positive or negative. The tool of the present disclosure provides a user interface showing a dependency graph 502 and functionalities 504 for enabling users to analyze the graph interactively.

Referring back to FIG. 8, at 804, the most influential chains looked for in a dependency graph. In one embodiment, a goal model is used to recognize what should be the crucial KPIs and their relations among the other KPIs. In this scenario, “Environmental goal” is linked to mpg in the goal model, which gives the dependency graph a focal KPI, mpg, to start the analysis.

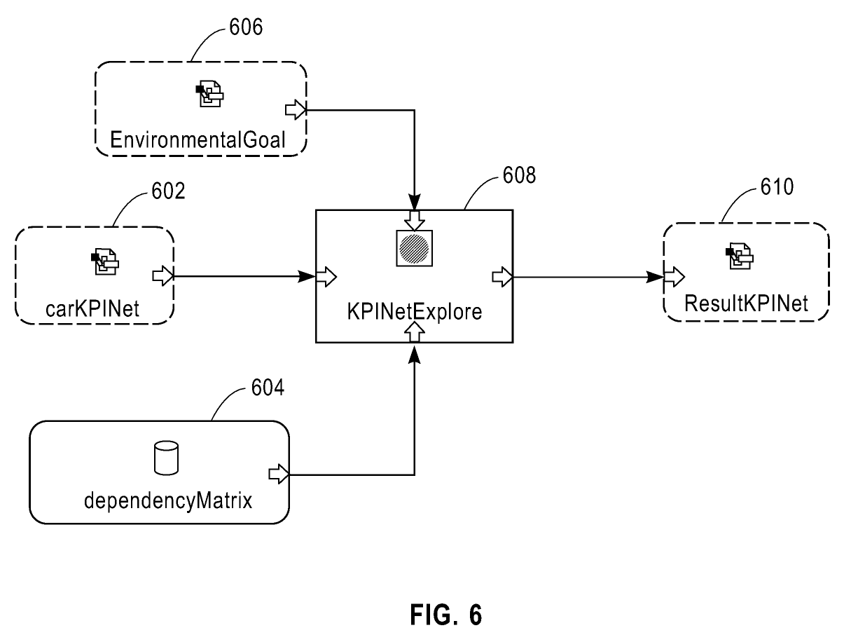

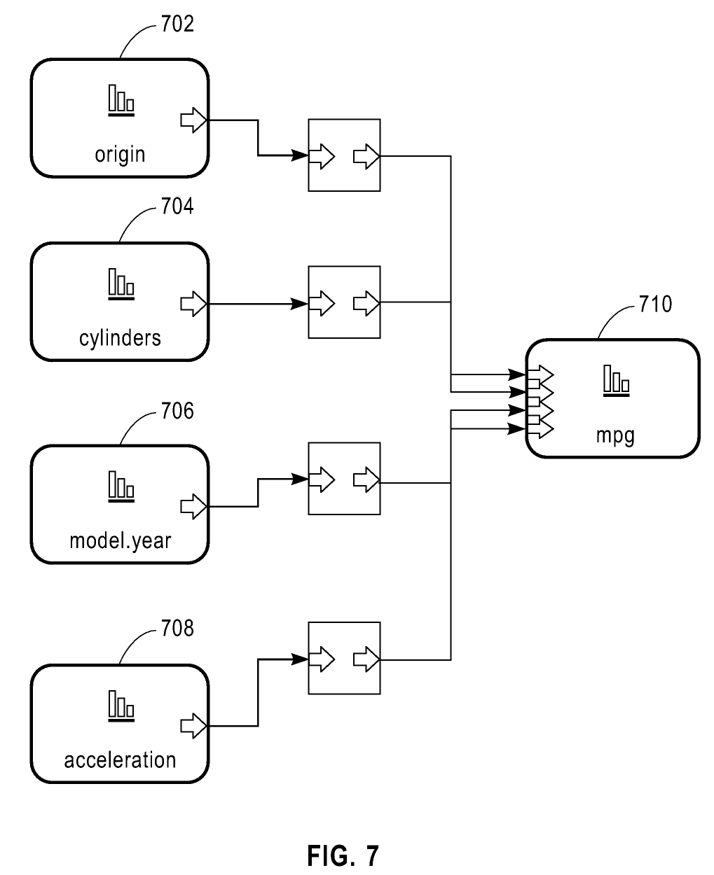

FIG. 6 shows a control flow in the control flow editor with three inputs, which are the goal model, a set of KPIs, and the dependency graph that enables finding the most influential chain. The set of KPIs and the dependency graph were obtained by the process described and shown with reference to FIG. 8 at step 802. In FIG. 7, “KPI Net Explore” element 608 refers to one of the analytic services provided in the tool of the present disclosure. The KPI Net Explore component or like 608 in one embodiment finds the most influential chain using these three inputs 602, 604, 606 and outputs a KPI Net 610.

The following shows a part of an example WSDL file of KPI Net Explore.

```
<wsdl:message name=“getInfluenceInRequest”>
    <wsdl:part name=“goalModel” type=“impl:GoalModel”/>
    <wsdl:part name=“dependenchGraph”
            type=“impl:DependencyGraph”/>
    <wsdl:part name=“kpiNet” type=“impl:KPINet”/>
    <wsdl:part name=“threshold” type=“xsd:double”/>
</wsdl:message>
<wsdl:message name=“getInfluenceInResponse”>
    <wsdl:part name=“getInfluenceInReturn”
            type=“impl:KPINet”/>
</wsdl:message>
<wsdl:message name=“getInfluenceOutResponse”>
    <wsdl:part name=“getInfluenceOutReturn”
            type=“impl:KPINet”/>
</wsdl:message>
<wsdl:message name=“getInfluenceOutRequest”>
    <wsdl:part name=“goalModel” type=“impl:GoalModel”/>
    <wsdl:part name=“dependencyGraph”
            type=“impl:DependencyGraph”/>
    <wsdl:part name=“kpiNet” type=“impl:KPINet”/>
    <wsdl:part name=“threshold” type=“xsd:double”/>
</wsdl:message>
<wsdl:portType name=“KPINetExplore”>
    <wsdl:operation name=“getInfluenceIn”
            parameterOrder=“in0 in1 in2 in3”>
        <wsdl:input message=“impl:getInfluenceInRequest”
                name=“getInfluenceInRequest”/>
        <wsdl:output message=“impl:getInfluenceInResponse”
                name=“getInfluenceInResponse”/>
    </wsdl:operation>
    <wsdl:operation name=“getInfluenceOut”
            parameterOrder=“in0 in1 in2 in3”>
        <wsdl:input message=“impl:getInfluenceOutRequest”
                name=“getInfluenceOutRequest”/>
        <wsdl:output message=“impl:getInfluenceOutResponse”
                name=“getInfluenceOutResponse”/>
    </wsdl:operation>
</wsdl:portType>
<wsdl:binding name=“KPINetExploreSoapBinding”
        type=“impl:KPINetExplore”>
    <wsdlsoap:binding style=“rpc”
            transport=“http://schemas.xmlsoap.org/soap/http”/>
    <wsdl:operation name=“getInfluenceIn”>
        <wsdlsoap:operation soapAction=“”/>
        <wsdl:input name=“getInfluenceInRequest”/>
        <wsdl:output name=“getInfluenceInResponse”/>
    </wsdl:operation>
    <wsdl:operation name=“getInfluenceOut”>
        <wsdlsoap:operation soapAction=“”/>
        <wsdl:input name=“getInfluenceOutRequest”/>
        <wsdl:output name=“getInfluenceOutResponse”/>
    </wsdl:operation>
</wsdl:binding>
<wsdl:service name=“KPINetExploreService”>
    <wsdl:port binding=“impl:KPINetExploreSoapBinding”
            name=“KPINetExplore”>
        <wsdlsoap:address location=“http://localhost:8080/
                axis/services/KPINetExplore”/>
    </wsdl:port>
</wsdl:service>
</wsdl:definitions>
```

The above example of a WSDL file includes two operations which are “getInfluenceIn” and “getInfluenceOut”. “getInfluenceIn” finds KPIs which influence the focal KPI. “getInfluenceOut” finds KPIs which the focal KPI influences. These two operations take three inputs 602, 604, 606 shown in the control flow in FIG. 6. In one embodiment, a threshold is also used as an input parameter to the two operations. The threshold, for example, is used to limit the number of KPIs when a newly generated KPI Net is saved at step 804 of FIG. 8.

The example scenario discovers which KPIs are key players in order to drive the goal in a process designing gas efficient car. In this scenario, it may not be sufficient to monitor mpg only, given the fact that other KPIs associated with automobile or car might influence mpg directly or indirectly. From the underlying correlation graph, one may observe multiple chains/paths an influence may propagate through. From business management perspective, executives would like to know the most significant impacts other KPIs have on the goal KPI, if there is any, so that the decision making can be focused. The tool of the present disclosure provides a functional option to find the most influential chains, which enables impact analysis between a source KPI and a destination KPI, for example, by using a most influential chain algorithm. A user, for instance, may invoke such a function using a screen 500 or interface shown in FIG. 6 or like. Selecting the “influence” box 502 would initiate the analysis.

In one embodiment of the present disclosure, an algorithm provided for finding the most influential chain considers a weighted directed KPI graph discovered at step 802 in FIG. 8. In one embodiment, a short path algorithm is used, however, instead of summation, multiplication is defined as the edge operator to aggregate correlations. For instance, along the chain A->B->C, if KPI A has a positive influence factor 2 on KPI B and KPI B has a negative factor −3 on KPI C, the influence A has on C will be 2*−3=−6. Given a source vertex s and a destination vertex e, the goal is to find the chains (paths) having maximum possible positive multiplication and minimum possible negative multiplication of its component edges' weights.

Selection of ending nodes can be obtained from a goal model when it is invoked. The following illustrates an example algorithm for find the most influential chain algorithm in one embodiment.

```
Root KPI : s
Each vertex v has two distance metric variables :
D_{Pos}[v] : most positive influence s has on v
D_{Neg}[v] : most negative influence s has on v
Edge weight : d(u, v) 6 ≠ 0
        d(u, v) : influence factor between u and v
Initially : D_{Pos} [s] = 1.0; D_{Neg} [s] = 1.0;
        v ≠ s : D_{Pos} [v] = 0.0;D_{Neg} [v] = 0.0
Relaxation step over edge(u; v) :
D_{Pos} [v]
        = max {D_{Pos} [v], D_{Pos} [u] * d(u; v)} if d(u, v) > 0
        = max {D_{Pos} [v], D_{Neg} [u] * d(u; v)} if d(u, v) < 0
DNeg[v]
        = min {D_{Neg} [v], D_{Neg} [u] * d(u; v)} if d(u, v) > 0
        = min {D_{Neg} [v], D_{Pos} [u] * d(u; v)} if d(u, v) < 0
```

The above algorithm may be adaptations of the classic shortest path algorithm, where rather two “influence” metrics, positive and negative, are kept at each vertex as the distance metric. Multiplication replaces summation at each relaxation step, and multiplication operator may change the sign of a distance metric during iterations. The algorithm finds both paths with most positive influence and negative influence the starting KPI has on the ending KPI. If no positive influence is found between two KPI nodes, the most positive influence will be zero. Similarly, if no negative influence is found between two KPI nodes, the most negative influence will be zero influence.

Referring to FIG. 8, the results of the analytic tool are saved as a KPI Net for refinement at 806. The tool of the present disclosure in one embodiment supports not only discovering the most influential chains but can also save the result as a KPI Net based on a threshold. FIG. 7 shows an example of a resulting KPI Net saved by the tool. The threshold of absolute values for impacts was set to be >1.0. The refined KPI Net in FIG. 7 shows mpg, which is most strongly influenced by four KPIs, the origin (where the car was made) 702, the number of cylinders 704, the model year 706, and the acceleration 708. Users may refine the KPI Net using the editing functions in the tool to specify which event sources inputs are used, how the KPI is calculated from the events, and so on. The tool aids in designing the KPI Net and efficiently developing KPI applications by mining from data repository in one embodiment.

While the use of the tool and system and method of the present disclosure was shown with reference to an automobile business example scenario, the tool may be also to other application, such as large-scale service compositions in which a high volume of KPIs exists.

In another embodiment, if the historical data is not available for mining KPIs and correlations or if user desires to provide such information instead, a user may provide the KPIs with relationships and relevance weights using an editor provided in the tool of the present disclosure. A graphical editor may be used to specify pair wise relationship between KPIs. The relationship may be defined as a function map from KPI x to KPI y. The user may calibrate the relevance based on their expertise and assign a relevance factor. In the presence of multivariate correlation, an intermediate map node is introduced to KPI Net editor to represent functional map such as z=f(x,y, . . . ). All independents are connected to the intermediate node with incident links, and the sole outgoing link points from the intermediate to the dependent KPI.

After all essential mutual relationships among KPIs are captured on the editor, the topology of KPI Network as a whole may be shown on a graphical view. This is in fact similar to generating a graph after the adjacency matrix is specified. The layout of KPI Net, however, is a scenario based choice with constraints on nodes and links. First, the layout takes on an ego-centric view centering on the highlighted KPI nodes. For instance, the neighborhoods of highlighted KPIs are searched in a breath-first fashion in the process of discovering network topology. In the case of Tree layout, the solely picked KPI will become the root. Meanwhile, the links may be limited to include only incoming links representing the incoming influence to the selected KPIs, or outgoing links only for contributing impact originated from the selected KPIs.

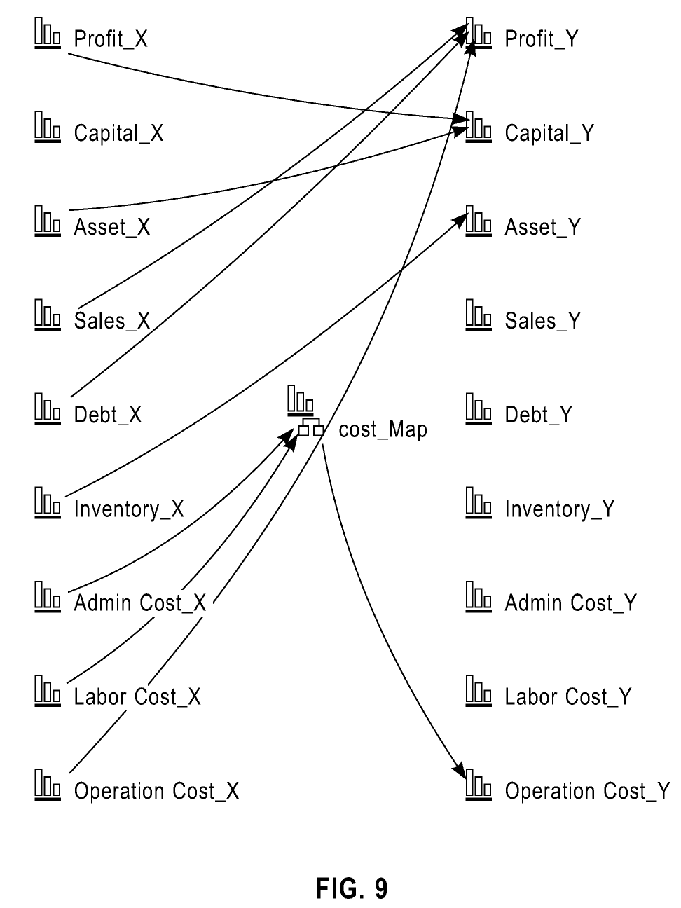

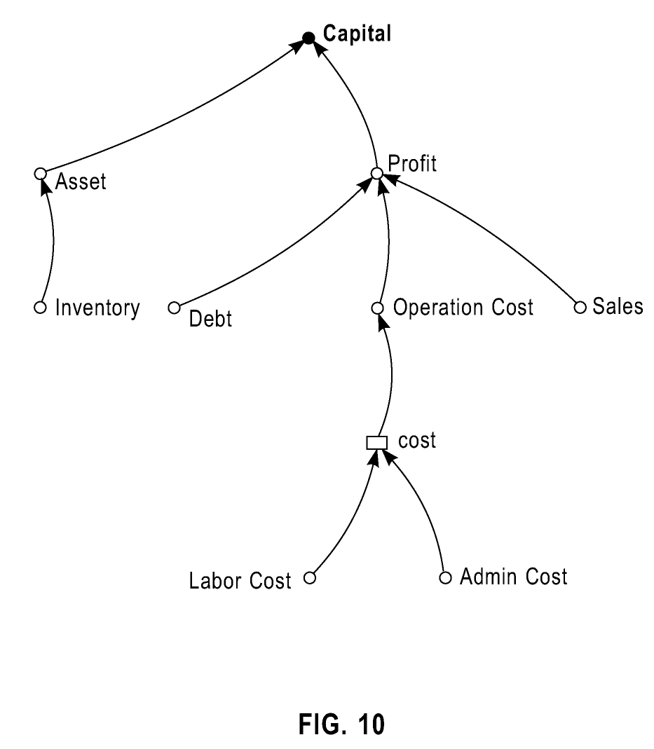

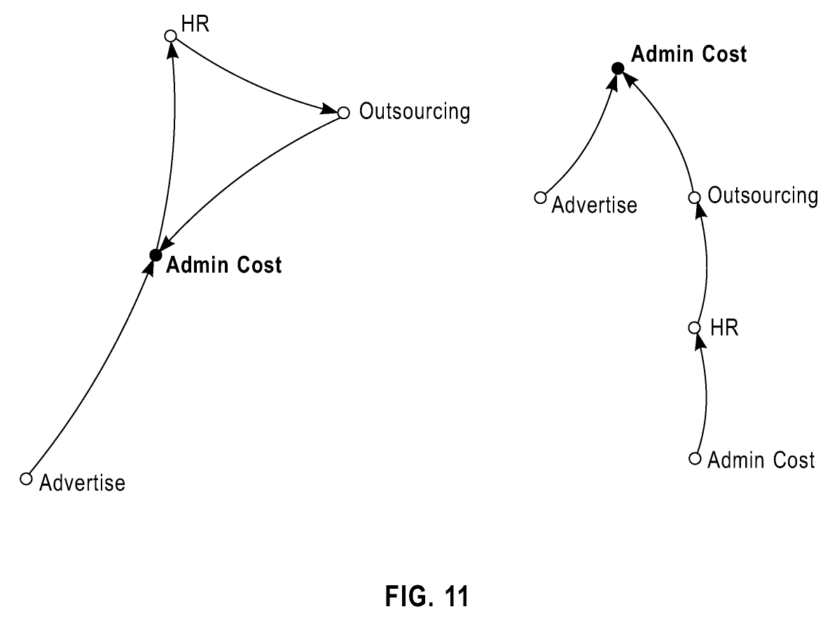

The users of KPI network may be interested in knowing how a local change has impact in global context. For instance, how a KPI change caused by local resource reallocation will affect other KPIs. The editor or like may impose above layout constraints mainly to facilitate flexible impact analysis in which the user may change focal KPIs and a corresponding ego-centric KPI network will be re-generated from the set of relationships specified in the graphical editor. Exploring the KPI network neighborhood centered on the focal KPI enables the decision makers to quickly spot patterns/problems that are originated from or aggregated to the selective KPIs. In FIG. 10, a KPI tree is generated from the editor example shown in FIG. 9. A KPI used to measure the progress of business activities is chosen as the root and incoming constraint is imposed. Tree layout may be particularly useful by business user. In one embodiment, when loop exist implicitly in the editor, the tool of the present disclosure may break the loop with duplicated nodes in order to adopt a tree layout. To avoid blunt duplication, each node may be only traversed once for children discovery. FIG. 11 demonstrates such an example.

Each KPI node in KPI Network may have multiple attributes, thus can be represented as a multidimensional vector in data domain. The basic technique of visualizing the data is mapping the KPI attributes to graphic entities in various color and shape. The semantic of data value is reflected through the graphical attributes of pixel representations.

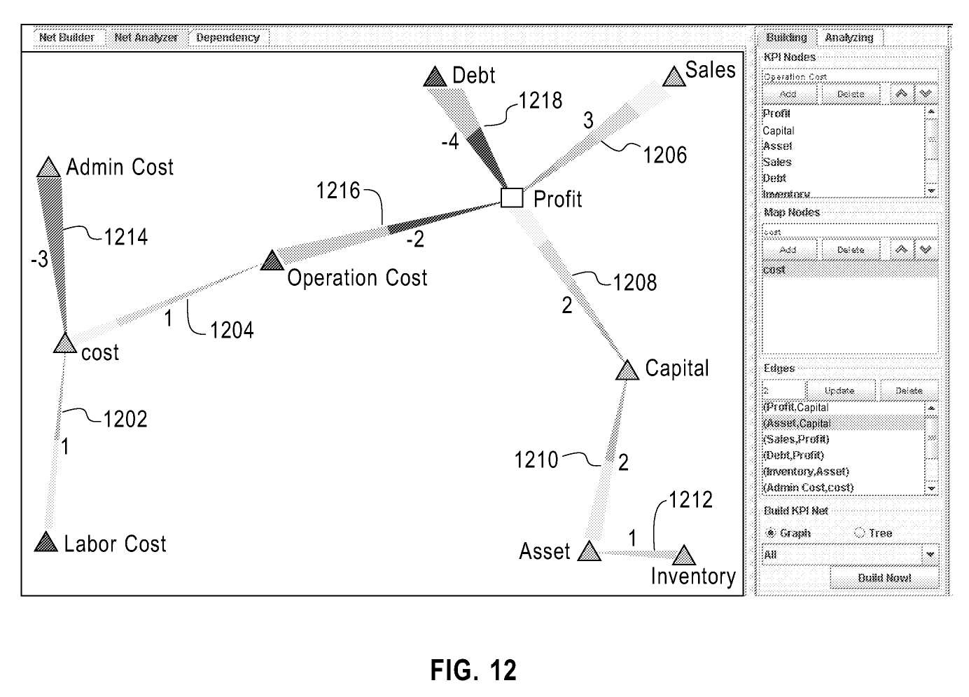

The tool of the present disclosure in one embodiment may map the data of same attribute of each node to a shape or color map. For example, the percentage difference from the 4th quarter expectation is mapped to a color ramp from red to green. Red may represent below the expectation values and green may represent equal or beyond values. In this way, the data will overlay onto the KPI topology. This overview snapshot will indicate the progress toward the target for the entire chosen structure at a glance, for example, as shown in FIG. 12. This allows straightforward comparison among KPIs. If the difference between target and current value can be visually highlighted by color, the bottleneck of reaching target within a structured KPI network can be readily detected. On the contrary, if one KPI will always outperform the rest, once it is identified, one can focus on investigating why it outperforms the rest. Among many KPI attributes that can be mapped, there are averages, min/max over the same period time, degree of connectivity, for instance, for example, represented as polygon shapes in FIG. 12, etc.

KPI network verification checks by evidence if the connectivity presented by KPI network reflects the intrinsic relationships in data. It also serves as a way to detect abnormity or new relationships that are not captured in the KPI network. We display the KPI network topology with quantifiable attributes assigned to each link and coded by color/shape. The attributes represent the correlations between the two ending nodes connected by the link. For example in FIG. 12, linear regression may be used to calculate the influence between one KPI as X, and the other KPI as Y, red link (1214, 1216, 1218) indicates a negative slope, while green (1202, 1204, 1206, 1208, 1210, 1212) indicates a positive one. The width of the link is proportional to the absolute value of slope.

In one embodiment, the verification may be a two way process. User can either verify the linkage discovered by data mining; or user can select a set of KPIs beforehand that describe best the organizational or procedural business model. Those picked KPIs will become the input to conventional multi-variant data mining method to discover coherent trend or correlations.

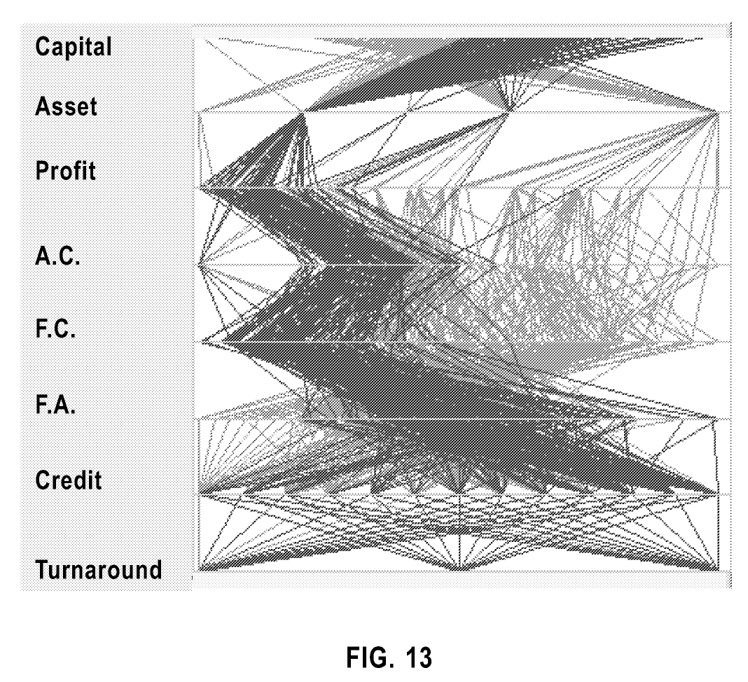

KPI value often takes on a range. On the other hand, KPI values are often monitored by ranges, which correspond to different “health condition”. The association rule of those ranges that co-occur may be identified, so that the user can make reasoning on KPIs with range association. Parallel coordinate technique may be used in KPI visualization to transform color coded KPI historical data in a dense display. When data falling within a certain KPI range are “brushed”, other co-occurring KPIs may be also highlighted. In FIG. 13, each zigzagged line from the top “Capital” (e.g., company's capital) to the bottom “Turnaround” represents one time instance. When historical Capital data in upper half range are “brushed” in red, other KPIs co-occurring may be also highlighted in red. The range association is easy to spot in such a view, giving user hints of investigating concepts such as why Fixed Cost is always low when Capital is high.

In selecting which KPIs to monitor and analyze together, the tool in one embodiment may limit them to those factors that are determined to be essential or substantially so to the organization reaching its goals. The number of KPIs is kept small to keep everyone's attention focused on the same influence chain. Influence chain refers to the KPI network nodes that have same positive/negative influence at higher level. For example, there may be three or four Key Performance Indicators for the company cost goals and all the units under it will have three, four, or five KPIs that support the overall company cost deduction and can be “rolled up” into them. KPIs network can be partitioned from top down into different influence chains.

There are several ways to find the “alignment” of KPI nodes that act to direct and reinforce common goals and purpose. If all historic data is stacked and displayed in a dense way, the data changing pattern at each node may be discovered. The trends may be traced in a “drill-down” matter, and find the most positive and negative influencing chain among all possible paths between a given source and destination.

The most positive/negative influencing chain is particularly useful in impact analysis, because they provide upper and lower bounds on the sensitivity analysis. An example of the algorithm of finding most positive/negative influencing chains was described above.

Various aspects of the present disclosure may be embodied as a program, software or computer instructions embodied in a computer or machine usable or readable medium, which causes the computer or machine to perform the steps of the method when executed on the computer, processor, and/or machine.

Time delay among KPIs is a key attribute in the data analysis. The tool of the present disclosure in one embodiment may find the shortest time delay between a given source KPI and a destination KPI. In the KPI Net construction phase in one embodiment, pair wise time delay is discovered from historical data or specified by user, and is assigned as link weight between two KPIs. In order to find out how soon a change at source will reach the destination, the shortest path algorithm is run using time delay as distance metric.

The system and method of the present disclosure may be implemented and run on a general-purpose computer or computer system. The computer system may be any type of known or will be known systems and may typically include a processor, memory device, a storage device, input/output devices, internal buses, and/or a communications interface for communicating with other computer systems in conjunction with communication hardware and software, etc.

The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, server. A module may be a component of a device, software, program, or system that implements some “functionality”, which can be embodied as software, hardware, firmware, electronic circuitry, or etc.

The embodiments described above are illustrative examples and it should not be construed that the present invention is limited to these particular embodiments. Thus, various changes and modifications may be effected by one skilled in the art without departing from the spirit or scope of the invention as defined in the appended claims.

We claim:

1. A method for constructing and exploring KPI networks, comprising:
identifying one or more key performance indicators associated with a selected performance target;
determining one or more correlations to said one or more key performance indicators;
assigning weights to said one or more correlations, said weights representing influence value between correlated key performance indicators; and
determining one or more influential chains in said one or more correlations, said one or more influential chains indicative of factors affecting the selected performance target.

2. The method of claim 1, wherein the step of identifying includes mining said one or more key performance indicators from historical data.

3. The method of claim 1, wherein the step of identifying is performed using user input.

4. The method of claim 1, wherein the step of identifying includes mining said one or more key performance indicators from a business process.

5. The method of claim 1, wherein the step of determining one or more correlations uses a predictive algorithm.

6. The method of claim 1, wherein the step of determining one or more correlations uses a linear regression algorithm.

7. The method of claim 1, wherein the step of determining one or more correlations further includes generating a key performance indicator network comprising at least a set of key performance indicators and their relations.

8. The method of claim 1, wherein the step of determining one or more influential chains includes using a shortest path algorithm.

9. The method of claim 8, wherein the shortest path algorithm multiplies weights in a path.

10. A system for constructing and exploring KPI networks, comprising:
a computer implemented processing module operable to identify one or more key performance indicators associated with a selected performance target;
a computer implemented analytic module operable to determine one or more correlations to said one or more key performance indicators and generate a key performance indicator network comprising said one or more key performance indicators and said one or more correlations; and
a processing module operable to determine one or more influential chains in said one or more correlations, said one or more influential chains indicative of factors affecting the selected performance target.

11. The system of claim 10, wherein said analytic module is further operable to assigning weights to said one or more correlations, said weights representing influence value between correlated key performance indicators; and
said processing module is further operable to determine one or more influential chains using said weights.

12. The system of claim 10, further including a user interface operable to enable a user to view said key performance indicator network, edit said one or more key performance indicators, and validate said determine one or more influential chains.

13. The system of claim 10, further including:
an editor module operable to allow a user to enter said one or more key performance indicators associated with a selected performance target.

14. The system of claim 13, wherein the editor module is further operable to enable a user to enter weights corresponding to said one or more correlations.

15. The system of claim 10, wherein said computer implemented processing module includes a data mining engine, said data mining engine mining said one or more key performance indicators from a data warehouse.

16. The system of claim 10, wherein said computer implemented processing module includes a data mining engine, said data mining engine mining said one or more key performance indicators from a business process.

17. The system of claim 10, wherein said processing module is operable to determine one or more influential chains using a shortest path algorithm.

18. The system of claim 10, wherein said computer implemented analytic module is operable to determine one or more correlations using linear regression algorithm.

19. A program storage device readable by a machine, tangibly embodying a program of instructions executable by the machine to perform a method of constructing and exploring KPI networks, comprising:
identifying one or more key performance indicators associated with a selected performance target;
determining one or more correlations to said one or more key performance indicators;
assigning weights to said one or more correlations, said weights representing influence value between correlated key performance indicators; and
determining one or more influential chains in said one or more correlations, said one or more influential chains indicative of factors affecting the selected performance target.

20. The program storage device of claim 19, wherein the step of identifying includes mining said one or more key performance indicators from historical data.
